(19) United States
(12) Patent Application Publication
(10) Pub. No.: US 2014/0120280 A1
(43) Pub. Date: May 1, 2014

(54) ADDITIVE COMPOSITION FOR CAUSTIC REMOVABLE HOT MELT ADHESIVES AND FORMULATIONS CONTAINING THE SAME

(71) Applicants: William R. Dougherty, Lancaster, PA (US); Nestor P. Hansen, Coatesville, PA (US)

(72) Inventors: William R. Dougherty, Lancaster, PA (US); Nestor P. Hansen, Coatesville, PA (US)

(73) Assignee: Cray Valley USA, LLC, Exton, PA (US)

(21) Appl. No.: 14/111,646

(22) PCT Filed: Apr. 11, 2012
(86) PCT No.: PCT/US12/33026

§ 371 Date: Jan. 14, 2014

Related U.S. Application Data
(60) Provisional application No. 61/475,756, filed on Apr. 15, 2011.

(51) Int. Cl. C09J 11/08; G09F 3/10; C09J 7/02; C08K 5/11; C08K 5/1539

(52) U.S. Cl. CPC C09J 11/08; C08K 5/11; C08K 5/1539; C09J 7/0203; G09F 3/10
USPC 428/34.7; 524/315; 524/112; 428/349; 428/35.7; 428/35.9

(57) ABSTRACT

An additive composition for imparting caustic removability to a hot melt adhesive includes an ester functionalized polymer having a polymeric backbone and, pendent thereon, one or more dicarboxylic acid moieties in at least partial ester form. The polymeric backbone has a weight average molecular weight less than 50,000. The ester functionalized polymer may be, for example, an at least partial ester of a maleated hydrocarbon. The additive may further include a low molecular weight α,β ethylenically unsaturated anhydride-containing or acid-containing polymer. A caustic removable hot melt adhesive composition comprises a hot melt adhesive additive and a conventional hot melt adhesive resin. A caustic removable adhesive label comprises a substrate and a caustic removable hot melt adhesive composition which includes an additive composition. The caustic removable hot melt adhesives can be used on labels for articles, such as glass bottles.

### CROSS-REFERENCE TO RELATED APPLICATION

This application is a U.S. National Phase Application of PCT International Application PCT/US2012/033026 which claims the benefit of U.S. Provisional Application No. 61/475,756, filed Apr. 15, 2011, the contents of which are incorporated herein in their entireties for all purposes.

### FIELD OF INVENTION

This invention relates to hot melt adhesive formulations which have properties enabling caustic removability. More particularly, the invention relates to an adhesive additive composition for imparting caustic removability to a hot melt adhesive. Additionally, this invention relates to the hot melt adhesive composition including the additive composition, to the adhesive labels which employ the hot melt adhesive composition, and to the articles upon which the adhesive label is adhered with the adhesive composition of the invention.

### BACKGROUND OF THE INVENTION

Hot melt adhesives typically exist as entirely solid materials which do not contain or require any solvents. They are solid materials at ambient room temperature but can be converted to a flowable liquid or fluid state by the application of heat, in which state they may be applied to a substrate. On cooling, the adhesive regains its solid form and gains its cohesive strength. In this regard, hot melt adhesives differ from other types of adhesives, such as water-based adhesives, which achieve the solid state by evaporation, removal of solvents, polymerization, or other means.

These adhesives are particularly useful in the manufacture of a variety of industrial or consumer goods where bonding of various substrates is necessary. An advantage of hot melt adhesives is the absence of a liquid carrier, as would be the case for water-based or solvent-based adhesives, which requires a drying step during application of the adhesive. Suitable hot melt adhesives possess the appropriate bond strength to adhere the substrates involved, and also demonstrate adequate flexibility, no staining or bleedthrough of the substrate, suitable viscosity and open time to function on a variety of substrates, acceptable stability under storage conditions, and acceptable thermal stability under normal application temperature.

Hot melt adhesives may be formulated to be relatively hard and free of tack or, in contrast, to be pressure sensitive, i.e., relatively soft and tacky at room temperature. Hot melt adhesives are increasingly utilized for affixing labels to various substrates, such as to glass or plastic bottles. Pressure sensitive hot melt adhesives for labeling are usually categorized as either removable or permanent. Permanent adhesives are formulated to cause the label to tear upon removal from the substrate. On the contrary, removable adhesives must allow the label to be removed from the substrate with a clean release, i.e., leaving no residue and without the tear of the label stock which occurs in a permanent adhesive application.

Solid hot melt adhesives for permanent adhesives have been widely used for many years. However, a hot melt adhesive, and more particularly a hot melt pressure sensitive adhesive, that gives good removability has not been available. Current removable adhesives are supplied for label stock from acrylic latices and solvented solution adhesives. Both of these materials have high molecular weight polymers that reduce flow on a surface to prevent build up of adhesion. In contrast, hot melt adhesives, in particular hot melt pressure sensitive adhesives, are based on materials having lower molecular weight polymers and high amounts of very low molecular weight components that make reduced flow or wetting on a surface very difficult.

Many different polymers have been used in hot melt adhesives employed in the construction of industrial or consumer goods. Typical hot melt adhesives have employed polymers which have included tri-block copolymers such as styrene-isoprene-styrene (SIS); styrene-butadiene-styrene (SBS); styrene-isoprene-butadiene-styrene (SIBS); styrene-ethylene-propylene-styrene (SEPS); styrene-ethylene-butylene-styrene (SEBS); ethylene-vinyl acetate (EVA) copolymers; and/or amorphous poly-alpha-olefin (APAO). Although these polymers, when properly blended, provide adhesion to most substrates, they are not suitable for certain particular uses. One shortcoming of the prior hot melt adhesives concerns their removability, which is an important feature for purposes of recycling the substrate.

To improve removability of the hot melt adhesive, the prior art has aimed to increase the water-solubility or water-dispersibility characteristics of the adhesive. For example, one known water sensitive hot melt adhesive composition which may be utilized in the manufacturing of disposable goods, especially disposable nonwoven articles, combines high dry bond strength with increased water solubility, thereby permitting the component elements of the disposable article to be recycled or otherwise disposed of in an environmentally friendly manner (i.e., degraded). Other known adhesives relate to a water-soluble or water-dispersible hot melt composition based on graft copolymers. These water-removable hot melt adhesives are used for labelling returnable bottles at high speeds, wherein the labels can be removed by brief soaking in hot water. However, these water-soluble compositions are not favorably employed to adhere labels to glass bottles, where water-resistant characteristics are desired as much as the clean removability of pressure sensitive labels.

Conventional styrene-isoprene-styrene (SIS) block copolymer/hydrocarbon (HC) tackifier-based hot melt adhesives have been used to adhere labels to glass bottles for decades. One of the beneficial properties of these types of adhesives for this application is that they can withstand a 7-day water immersion test. Accordingly, these types of adhesives are known for their favorable water-resistant characteristics. However, this presents a difficult challenge when the labels and adhesives need to be removed in a glass bottle recycling process. Hot caustic baths are successfully used to remove many water-based label adhesives. However, the hot melt adhesives are very resistant to caustic.

### SUMMARY OF THE INVENTION

A new additive has now been developed which imparts caustic removability to conventional hot melt adhesives without significantly sacrificing adhesive performance. For example, particular additives of the present invention impart caustic removability to styrene-isoprene-styrene (SIS) block copolymer/hydrocarbon (HC) tackifier-based hot melt adhesives. An adhesive containing the additive may be formulated to achieve similar water resistance and adhesive strength properties as when the additive is not present, while enabling the complete removability of the labels in caustic baths for recycling purposes. The adhesive containing the additive may be applied to a substrate, such as paper for an adhesive label, for adhesion to an article such as a glass bottle or container. The presence of such an additive in a hot melt adhesive composition improves the caustic removability of the adhesive while maintaining the viscoelastic performance characteristics and adhesive properties of the hot melt adhesive composition.

The present invention relates to an adhesive additive composition for imparting caustic removability to a hot melt adhesive. Additionally, this invention relates to a hot melt adhesive composition, particularly a hot melt pressure sensitive adhesive composition, which includes the adhesive additive composition. The present invention also relates to a hot melt adhesive label, which includes the hot melt adhesive composition and the adhesive additive composition, that is removable by a caustic solution. Furthermore, the invention relates to an article upon which the adhesive label is adhered with use of the adhesive composition of the invention.

According to a first embodiment, the present invention relates to an additive composition for imparting caustic removability to a hot melt adhesive. The additive composition comprises an ester functionalized polymer comprising a polymeric backbone and, pendent thereon, one or more dicarboxylic acid moieties in at least partial ester form. The terms “polymer” and “resin” are to be interpreted in the present invention as having the same meaning, namely a naturally occurring or synthetic compound consisting of large molecules made up of a linked series of repeated monomers obtained by, for example, a polymerization process. In at least one embodiment of the present invention, the polymeric backbone is aliphatic. In other embodiments, the polymeric backbone may contain aliphatic as well as aromatic repeating units. The polymeric backbone has a low molecular weight. As used herein, the term “low molecular weight” means an average molecular weight less than about 50,000. In some embodiments of the present invention, the ester functionalized polymer is an at least partial ester of a maleic anhydride grafted hydrocarbon polymer. The term “graft copolymer” is meant to mean a polymer in which the main backbone chain has attached to it at various points side chains containing different atoms or groups from those in the main chain. The main chain may be a copolymer or may be derived from a single monomer.

In at least one particular embodiment, the additive composition further comprises a low molecular weight 0,13 ethylenically unsaturated anhydride-containing or acid-containing polymer selected from the group consisting of low molecular weight maleic anhydride homo-polymers and at least partial esters thereof, low molecular weight maleic anhydride olefin copolymers and at least partial esters thereof, and low molecular weight maleic anhydride vinyl aromatic copolymers and at least partial esters thereof, and combinations and mixtures thereof. In some embodiments of the present invention, the additive composition includes a low molecular weight maleic anhydride vinyl aromatic copolymer or an at least partial ester thereof, such as a low molecular weight styrene-maleic anhydride (SMA) or an at least partial ester thereof.

In a preferred example of this embodiment, the additive composition comprises a combination of polymers. Exemplary compositions of the present invention include, for example, an ester functionalized polymer comprising a polymeric backbone and, pendent thereon, one or more dicarboxylic acid moieties in at least partial ester form; and a low molecular weight maleic anhydride vinyl aromatic copolymer or an at least partial ester thereof. For example, in at least one embodiment of the present invention, the additive may include (i) an at least partial ester of a maleic anhydride grafted hydrocarbon polymer and (ii) a low molecular weight styrene-maleic anhydride (SMA) or an at least partial ester thereof.

The additive compositions of the present invention impart caustic removal properties to a conventional hot melt adhesive formulation. Adhesives formulated with such additives can be used in hot melt adhesive labels, particularly in hot melt pressure sensitive labels for recyclable glass articles, such as bottles. The labels can be removed with caustic, such as in a hot caustic bath, when the objects are recycled. Without being held to the theory, it is believed that the acid and/or anhydride groups of the additive components impart caustic solubility to the otherwise insoluble hot melt adhesive components. The dicarboxylic acids, in at least partial ester form, of the ester functionalized polymer component are believed to contribute to the desirable properties of the additive and the resulting adhesive formulation. For example, the additive imparts caustic solubility to the hot melt adhesive composition comprising a block copolymer, such as a styrene-isoprene-styrene (SIS) block copolymer; a tackifying resin, such as a hydrocarbon resin; and a process oil, such as mineral oil. The desired adhesive properties of the hot melt adhesive are retained even though the caustic removability property has been imparted by the addition of the additive.

In another embodiment, the present invention is a caustic removable hot melt adhesive composition, more particularly a hot melt pressure sensitive adhesive composition, which includes a hot melt adhesive additive. The hot melt adhesive composition is caustic removable and includes a hot melt adhesive additive which comprises an ester functionalized polymer comprising a polymeric backbone and, pendent thereon, one or more dicarboxylic acid moieties in at least partial ester form; and an adhesive resin selected from the group consisting of styrene-isoprene block copolymers, polyacrylate resins, poly ethylene vinyl acetate (EVA) resins, polystyrene butadiene resins, random styrenebutadiene (SBR) copolymers, styrene-butadiene block copolymers, styrene-ethylene-butylene-styrene (SEBS) block copolymers, amorphous poly-α olefin (APAO) resins, and mixtures thereof. In at least one particular embodiment, the additive composition further comprises a low molecular weight α,β ethylenically unsaturated anhydride-containing or acid-containing polymer selected from the group consisting of low molecular weight maleic anhydride homo-polymers and at least partial esters thereof, a low molecular weight maleic anhydride olefin copolymers and at least partial esters thereof, and low molecular weight maleic anhydride vinyl aromatic copolymers and at least partial esters thereof, and combinations and mixtures thereof. In a preferred example of this embodiment, the additive composition comprises an ester functionalized polymer comprising a polymeric backbone and, pendent thereon, one or more dicarboxylic acid moieties in at least partial ester form; and a low molecular weight maleic anhydride vinyl aromatic copolymer or an at least partial ester thereof. For example, in at least one embodiment of the present invention, the additive may include (i) an at least partial ester of a maleic anhydride grafted hydrocarbon polymer and (ii) a low molecular weight styrene-maleic anhydride (SMA) copolymer or an at least partial ester thereof. The present invention has a particular usefulness for labels on products which are to be recycled.

In yet another embodiment, the present invention is a caustic removable adhesive label comprising a substrate and a caustic removable hot melt adhesive composition comprising a hot melt adhesive additive. The hot melt adhesive additive comprises an ester functionalized polymer comprising a polymeric backbone and, pendent thereon, one or more dicarboxylic acid moieties in at least partial ester form; and an adhesive resin selected from the group consisting of styrene-isoprene block copolymers (such as styrene-isoprene-styrene (SIS) block copolymers), hydrocarbon tackifying resins, polyacrylate resins, poly ethylene vinyl acetate (EVA) resins, polystyrene butadiene resins, random styrenebutadiene (SBR) copolymers, styrene-butadiene block copolymers (such as a styrene-butadiene-styrene (SBS) block copolymer), styrene-ethylene-butylene block copolymers (such as a styrene-ethylene-butylene-styrene (SEBS) block copolymer), amorphous poly-α olefin (APAO) resins, and mixtures thereof. The adhesive composition is applied to the substrate for adhesion to an article. The label of the present invention may be a label which, after application of the caustic removable hot melt adhesive composition, may be adhered to an article such as a glass bottle. In at least one embodiment, the caustic removable adhesive label contains a hot melt adhesive composition including an additive composition, in which the additive composition comprises a combination of polymers. Exemplary two-part additive compositions of the present invention include, for example, an ester functionalized polymer comprising a polymeric backbone and, pendent thereon, one or more dicarboxylic acid moieties in at least partial ester form; and a low molecular weight maleic anhydride vinyl aromatic copolymer or an at least partial ester thereof. For example, in at least one embodiment of the present invention, the additive may include (i) an at least partial ester of a maleic anhydride grafted hydrocarbon polymer and (ii) a low molecular weight styrene-maleic anhydride (SMA) or an at least partial ester thereof. The adhesive additive may be soluble at room temperature in a caustic (basic) solution having a pH greater than 8.

In another embodiment, the present invention is an article having a caustic removable adhesive label. Particularly, the article is a container and a caustic removable adhesive label is adhered thereto. The label comprises a substrate, such as paper, and a caustic removable hot melt adhesive composition having an additive which comprises an ester functionalized polymer comprising a polymeric backbone, pendent thereon, one or more dicarboxylic acid moieties in at least partial ester form. The additive may be soluble in a caustic solution having a pH greater than 8. The container may be made of any suitable material including, for example, glass, metal (e.g., stainless steel), or plastic (e.g., a polyolefin such as high density polyethylene). The label adheres to the article with good adhesion properties, and the article and label are water resistant. The label becomes removable from the article upon being submerged in, or otherwise treated with, a caustic bath having a pH greater than 8.

### DETAILED DESCRIPTION OF THE INVENTION

The additive composition of the present invention, which imparts the caustic removability property to a conventional hot melt adhesive formulation, comprises an ester functionalized polymer comprising a polymeric backbone and, pendent thereon, one or more dicarboxylic acid moieties in at least partial ester form. More particularly, the ester functionalized polymer includes a polymeric backbone that may be aliphatic. The polymeric backbone has a low molecular weight defined as a weight average molecular weight less than about 50,000. The polymeric backbone may be, for example, a homopolymer of a C3 to C16 monomer or a copolymer of two or more C3 to C16 monomers. The one or more dicarboxylic acid moieties may be, for example, an at least partial ester of a dicarboxylic acid moiety. Such dicarboxylic acid moieties may be derived from, for example, a functionalizing agent selected from the group consisting of maleic acid, maleic anhydride, fumaric acid, itaconic acid, tetrahydrophthalic acid, and tetrahydrophthalic anhydride.

In some embodiments of the present invention, the ester functionalized polymer is an at least partial ester of a maleic anhydride grafted hydrocarbon polymer. The term “hydrocarbon polymer,” as used herein, is meant to define a class which includes those hydrocarbons copolymerized with styrenically aromatic-containing hydrocarbon monomers, up to and including C10 hydrocarbons. For example hydrocarbon polymers may contain alpha methyl styrene, indene, or other C4-C10 hydrocarbons. In such embodiments, the pendent dicarboxylic acid ester functional groups may be directly introduced onto the polymer backbone by a grafting reaction using, for example, an ester of maleic acid. Alternatively, a diacid or anhydride functionalizing agent, such as maleic anhydride, may be grafted onto the polymeric backbone and then reacted, for example, with an alcohol to form the ester, reacting 25 to 100% of the available anhydride functionality. The maleic anhydride grafted polymer may also be hydrogenated to remove unsaturation before being esterified. As used herein, the term “maleic anhydride grafted polymer” is equivalent to a “maleated polymer” or a “maleinized polymer,” such that a maleic anhydride functionalizing agent is grafted or otherwise affixed to the polymeric backbone to form a maleated or maleinized polymer.

In at least one embodiment of the present invention, the ester functionalized polymer is an at least partial ester of a maleic anhydride grafted hydrocarbon polymer containing a structure according to Formula I:

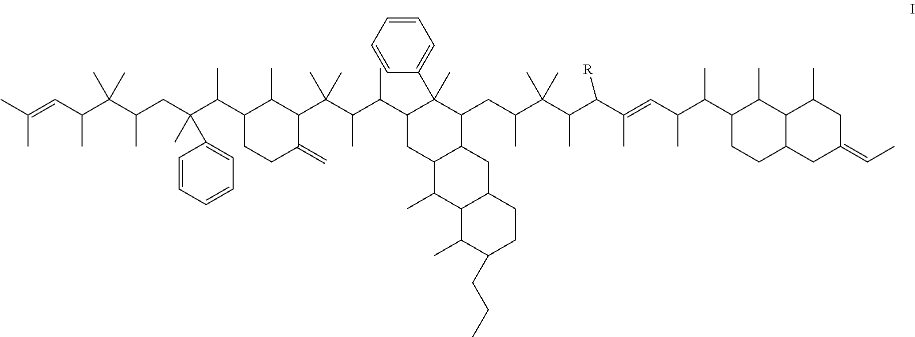

wherein R is maleic anhydride or a dicarboxylic acid moiety, the dicarboylic acid moiety having a structure according to Formula II:

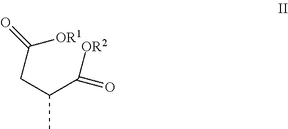

wherein R¹ and R² can be the same or different and are selected from H and any residue of an aromatic, aliphatic, linear, or branched C1-C12 monoalcohol, preferably a C2-C8 monoalcohol, provided that at least a portion of the acid groups in the polymer are in ester form, approximately 25 to 100% esterification. A person with ordinary skill in the art would appreciate that Formula I is a representation of some of the possible structures and configurations of a polymeric hydrocarbon. The maleic anhydride grafted polymer may also be hydrogenated to remove unsaturation before being esterified. The monoalcohol may be alkoxylated, such as with up to 16 alkoxy units from an ethoxy group and/or a propoxy group. The resin of Formula I can be any partially maleated hydrocarbon resin that is soluble to any degree in basic pH solutions. These maleated polymeric hydrocarbon resins have anhydride functionality. The degree of maleinization (or maleation) of the polymeric hydrocarbon can range from the least amount needed to render a given hydrocarbon partially soluble in a basic pH solution having a pH greater than 8, to as high a level of maleinization as is achievable, while retaining compatibility with the hot melt adhesive formulation components. The maleated polymeric hydrocarbon copolymer may have, for example, a maleic anhydride content (i.e., is maleated or maleinized) from 1% to 50% wt/wt, more preferably 5% to 30% wt/wt. In a preferred embodiment of the present invention, the additive composition includes a 9% maleated derivative of a polymeric hydrocarbon which has been at least partially esterified with an alcohol.

In at least one particular embodiment, the additive composition further comprises a low molecular weight α,β ethylenically unsaturated anhydride-containing or acid-containing polymer selected from the group consisting of low molecular weight maleic anhydride homo-polymers and at least partial esters thereof, low molecular weight maleic anhydride olefin copolymers and at least partial esters thereof, and low molecular weight maleic anhydride vinyl aromatic copolymers and at least partial esters thereof, and combinations and mixtures thereof. In some embodiments of the present invention, the additive composition includes a low molecular weight maleic anhydride vinyl aromatic copolymer or an at least partial ester thereof, such as a low molecular weight styrene-maleic anhydride (SMA) or an at least partial ester thereof.

In a particular embodiment of the present invention, the low molecular weight α,β ethylenically unsaturated anhydride-containing or acid-containing polymer which may be copolymers of the anhydride or acid with a co-monomer selected from vinyl aromatic monomers such as, for example, vinyl toluenes and styrene, or from ethylene and/or propylene. Preferably, the molar ratio of the co-monomer to the anhydride or acid ranges from about 1:1 to 3:1. The carboxylic anhydride vinyl aromatic copolymer is partially esterified by an alcohol, more particularly by a monoalcohol. For example, the carboxylic anhydride vinyl aromatic monomer copolymer may be at least partially esterified by an aromatic, aliphatic, linear, or branched C1-C12 monoalcohol, preferably a C2-C8 monoalcohol. The degree of monoesterification of the carboxylic anhydride copolymer may range, for example, from 25-100% of the initial anhydrides, preferably from 50-80% of the initial anhydrides. Additionally, the carboxylic anhydride vinyl aromatic copolymer can be any partial monoester of the copolymer which is soluble to any degree in basic pH solutions having a pH greater than 8. Anhydride groups, ester groups, as well as free acid groups or carboxylate salt groups may be present in the carboxylic anhydride vinyl aromatic copolymer. As a particular example, the anhydride-containing or acid-containing copolymer is a styrene-maleic anhydride copolymer, particularly with a molar ratio S:MA of styrene (S) to maleic anhydride (MA) ranging from about 1:1 to 3:1.

In a preferred example of this embodiment, the additive composition comprises a combination of polymers. Exemplary additive compositions of the present invention include, for example, an ester functionalized polymer comprising a polymeric backbone and, pendent thereon, one or more dicarboxylic acid moieties in at least partial ester form; and a low molecular weight maleic anhydride vinyl aromatic copolymer or an at least partial ester thereof. For example, in at least one embodiment of the present invention, the additive may include (i) an at least partial ester of a maleic anhydride grafted hydrocarbon polymer and (ii) a low molecular weight styrene-maleic anhydride (SMA) or an at least partial ester thereof. In at least one embodiment of the present invention, the low molecular weight styrene-maleic anhydride (SMA) is according to Formula II:

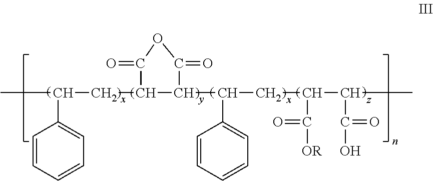

wherein n, R, x, y, and z are as described below.

The number of repeat units n may be from 7 to 72 and relates to the molecular weight of this additive component. R can be any residue of an aromatic, aliphatic, linear, or branched C1-C12 monoalcohol, preferably a C2-C8 monoalcohol. The monoalcohol may be alkoxylated, such as with up to 16 alkoxy units from an ethoxy group and/or a propoxy group. The SMA ester resin may have different molar ratios of styrene (S)/maleic anhydride (MA) co-monomer compositions, such as a molar ratio (x:(y+z)) in the range from about 1:1 to 3:1 and more preferably from about 1.4 :1 to 1.6:1. The molecular variables x, y, and z, relate to the molar ratios of S:MA such that x is from 1 to 4, a molar ratio of (x:(y+z)) is in the range from about 1:1 to 3:1, and the monoesterification molar ratio of (z/(y+z)) ranges from about 50 to 100%. The SMA ester resin can be any partial monoester of a styrene-maleic anhydride resin that is soluble to any degree in basic pH solutions having a pH greater than 8. These monoesters have both acid and anhydride functionality. Particular examples of monoalcohols which may comprise R of Formula II include, but are not limited to, isopropyl and cyclohexyl alcohols. For example, the additive composition may be an ether alcohol ester of a styrene-maleic anhydride (SMA) copolymer, which defines a 75% total monoester, and an S:MA ratio of between about 1.4:1 to about 1.6:1.

In one or more embodiments of the present invention, the one or more dicarboxylic acid moieties pendant to the polymeric backbone of the ester functionalized polymer are in accordance with Formula II, wherein R¹ and R² can be the same or different and are selected from H and any residue of an aromatic, aliphatic, linear, or branched C1-C12 monoalcohol, preferably a C2-C8 monoalcohol, subject to the proviso that in at least one of the dicarboxylic acid moieties at least one of R¹ or R² is C1 to C12 alkyl. The monoalcohol may be alkoxylated, such as with up to 16 alkoxy units from, for example, an ethoxy group and/or a propoxy group. The one or more dicarboxylic acid moieties may be, for example, from about 25 to 100% esterified. The one or more dicarboxylic acid moieties may be at least partially esterified with C1 to C6 aliphatic alcohols. In some embodiments, the one or more dicarboxylic acid moieties contain one or two ester groups having a structure —C(═O)OR wherein R is a C1 to C6 alkyl group.

The term “low molecular weight” according to the invention generally means a weight average molecular weight less than 50,000. When a low molecular weight carboxylic anhydride vinyl aromatic copolymer, such as a styrene-maleic anhydride, is used as part of an additive composition, the molecular weight may be affected by the degree of monoesterification, among other factors. The molecular weight of the styrene-maleic anhydride copolymer or resin may thus range from 1,000 to 50,000, or more preferably from 2,000 to 15,000. Similarly, when the ester functionalized polymer comprising a polymeric backbone and, pendent thereon, one or more dicarboxylic acid moieties in at least partial ester form, such as an at least partial ester of a maleated polybutadiene, is employed as the additive, the molecular weight may vary depending on the maleic anhydride content (e.g., the degree of maleinization) or by the degree of monoesterification, among other factors. The weight average molecular weight of the ester functionalized polymer may thus be in the range from 250 to 25,000, or more preferably from 500 to 10,000. The weight average molecular weight ranges are as measured by gel permeation chromatography (GPC) with polystyrene standards in tetrahydrofuran (THF).

In another embodiment, the present invention is a caustic removable hot melt adhesive composition, more particularly a hot melt pressure sensitive adhesive composition, which includes a hot melt adhesive additive. The hot melt adhesive composition is caustic removable and includes a hot melt adhesive additive which comprises an ester functionalized polymer comprising a polymeric backbone and, pendent thereon, one or more dicarboxylic acid moieties in at least partial ester form; and an adhesive resin selected from the group consisting of styrene-isoprene block copolymers, polyacrylate resins, poly ethylene vinyl acetate (EVA) resins, polystyrene butadiene resins, random styrenebutadiene (SBR) copolymers, styrene-butadiene block copolymers, styrene-isoprene-butadiene-styrene (SIBS), styrene-ethylene-propylene-styrene (SEPS), styrene-ethylene-butylene-styrene (SEBS) block copolymers, amorphous poly-α olefin (APAO) resins, and mixtures thereof. In at least one particular embodiment, the additive composition further comprises a low molecular weight α,β ethylenically unsaturated anhydride-containing or acid-containing polymer selected from the group consisting of low molecular weight maleic anhydride homo-polymers and at least partial esters thereof, a low molecular weight maleic anhydride olefin copolymers and at least partial esters thereof, and low molecular weight maleic anhydride vinyl aromatic copolymers and at least partial esters thereof, and combinations and mixtures thereof.

In a preferred example of this embodiment, the additive composition comprises an ester functionalized polymer comprising a polymeric backbone and, pendent thereon, one or more dicarboxylic acid moieties in at least partial ester form; and a low molecular weight maleic anhydride vinyl aromatic copolymer or an at least partial ester thereof. For example, in at least one embodiment of the present invention, the additive may include (i) an at least partial ester of a maleic anhydride grafted hydrocarbon polymer and (ii) a low molecular weight styrene-maleic anhydride (SMA) or an at least partial ester thereof. The present invention has a particular usefulness for labels on products which are to be recycled.

During manufacture of a caustic removable hot melt adhesive composition according to one of the embodiments of the present invention, an additive package is added during the compounding of the adhesive. The additive package contains a combination of a low molecular weight styrene-maleic anhydride copolymer ester and a maleated grafted hydrocarbon polymer ester. The components of the additive can be added in varying amounts. In some embodiments, from 0 to about 15 weight percent of each component of the additive is used, such that at least one ester functionalized polymer comprising a polymeric backbone and, pendent thereon, one or more dicarboxylic acid moieties in at least partial ester form is present in the additive. For an embodiment employing a low molecular weight styrene-maleic anhydride copolymer ester and a low molecular weight maleated grafted hydrocarbon polymer ester as components of the additive, preferably from about 1 to about 12 weight percent of each component is used. More preferably, the total weight content of the additive composition (i.e., total weight content of all component polymers of the additive composition) in the said hot melt adhesive composition is generally at least 3%.

An exemplary conventional hot melt adhesive, to which the additive of the present invention may be added, includes a styrene-isoprene-styrene (SIS) block copolymer, a hydrocarbon (C5 or C9) tackifying resin, a rosin ester tackifier, and/or a process oil. A SIS block copolymer may be employed in the hot melt adhesive, such as that which is sold by Kraton Performance Polymers Inc. of Houston, Tex. under the trade name Kraton D-1113. A C5 hydrocarbon tackifying resin may be utilized, such as that which is sold by Cray Valley U.S.A. of Exton, Pa. under the trade name Wingtack ET. A naphthenic process oil may be used in the hot melt adhesive as well, such as the one sold under the trade name Nyflex 222B by Nynas AB of Stockholm, Sweden. As is known to one skilled in the art, conventional hot melt adhesives may include a variety of other components including, but not limited to, starches, waxes, plasticizers, anti-oxidants, stabilizers, pigments, dyes, biocides, flame retardants, antistatic agents, or fillers. For example, the hot melt adhesive may include Ethanox 310, an antioxidant sold by Albemarle Corporation of Baton Rouge, La.

The additive of the present invention may be introduced to a conventional hot melt adhesive by any process known to one skilled in the art. For example, when an SMA copolymer ester and maleated polybutadiene ester are employed as the additive polymers, they may be introduced separately from each other and separate from, or in combination with, any of the individual components of the conventional hot melt adhesive. As a further example, the additive may be introduced to the components of a conventional hot melt adhesive comprising a styrene-isoprene-styrene (SIS) block copolymer, a hydrocarbon (C5-C9) tackifying resin, and a process oil. The SMA ester may be prepared from a commercially available low molecular weight styrene maleic anhydride copolymer product with high maleic anhydride contents, such as that sold by Cray Valley U.S.A. of Exton, Pa. under the trade name SMA. The maleated polymeric hydrocarbon ester may also be a commercially available product, such as that sold by Cray Valley U.S.A. of Exton, Pa. A process oil, such as mineral oil, may be added last. The hot melt adhesive containing the additive is allowed to mix on sigma blade mixer until it is homogeneous.

In yet another embodiment, the present invention is a caustic removable adhesive label comprising a substrate and a caustic removable hot melt adhesive composition comprising a hot melt adhesive additive. The hot melt adhesive composition can be used in hot melt adhesive labels, preferably in hot melt pressure sensitive adhesive labels, particularly for recyclable glass articles which may be containers such as bottles. The labels can be removed with caustic, for example in a hot caustic bath, when the objects are recycled. The hot melt adhesive additive comprises an ester functionalized polymer comprising a polymeric backbone and, pendent thereon, one or more dicarboxylic acid moieties in at least partial ester form; and an adhesive resin selected from the group consisting of styrene-isoprene block copolymers, hydrocarbon tackifying resins, polyacrylate resins, poly ethylene vinyl acetate (EVA) resins, polystyrene butadiene resins, random styrenebutadiene (SBR) copolymers, styrene-butadiene block copolymers, styrene-isoprene-butadiene-styrene (SIBS), styrene-ethylene-propylene-styrene (SEPS), styrene-ethylene-butylene-styrene (SEBS) block copolymers, amorphous poly-α olefin (APAO) resins, and mixtures thereof. The adhesive composition is applied to the substrate for adhesion to an article. Alternatively or additionally, the adhesive may be applied to the article with the substrate or label applied thereon, as would be appreciated by one having ordinary skill in the art. The label of the present invention may be a label which, after application of the caustic removable hot melt adhesive composition, may be adhered to an article such as a glass bottle. In at least one embodiment, the caustic removable adhesive label contains a hot melt adhesive composition including an additive composition, in which the additive composition comprises a combination of polymers. Without being held to the theory, it is believed that the acid and/or anhydride groups of the additive impart caustic solubility to the adhesive composition despite the presence of insoluble components such as styrene-isoprene-styrene (SIS) tri-block copolymer, hydrocarbon tackifying resin, and/or process oil. The present invention enables the manufacturing of a hot melt adhesive which has favorable water resistance and viscoelastic properties for adhesion to a substrate, for example the retention of a label on a glass bottle, while also imparting caustic removability to the hot melt adhesive formula. This allows for strong retention and adhesion characteristics when they are desired, but also removability of the hot melt adhesive from the substrate when it is necessary as in the recycling process.

The hot melt adhesive containing the additive may be applied to the label and/or the substrate by various processes known to one skilled in the art. In one representative process, the caustic removable hot melt adhesive of the present invention is melted and poured onto a blade coater. The blade coater can be employed to apply a thin film of the caustic removable hot melt adhesive to a release liner to which a face stock is laminated. The laminate may then be cut into label size strips for application to a substrate, such as a glass bottle.

In a further embodiment, the present invention is an article having a label adhered with a caustic removable hot melt adhesive composition containing an additive as defined above. For hot melt adhesive labels, particularly for hot melt pressure sensitive adhesive labels, the adhesive is coated onto a release liner, which is then immediately laminated with a label facestock, which could be paper or plastic. The article may be, for example, a container which may be made of any suitable material including, for example, glass, metal (e.g., stainless steel), or plastic (e.g., high density polyethylene). The label adheres to the article with good adhesion properties, and the article and label are water resistant (i.e., resistant to water having a substantially neutral pH). The label becomes removable from the article upon being submerged in, or otherwise treated with, a caustic bath having a pH greater than 8. The label is then applied to an article such as a glass bottle for identification and/or decorative purposes. After the contents of the article have been used, it may be desirable to recycle the article. To remove the label, articles can be placed in a hot caustic bath, which causes the adhesive to dissolve and/or delaminate from the article. The clean bottle or other article can then more easily be recycled without the contamination of the label and/or the adhesive. Until now, it has not been possible to remove conventional hot melt adhesive labels from articles in this way. Removal of the hot melt adhesive is made possible by adding the additive of the present invention.

Any process or component known in the art may be utilized to esterify the additive components of the present invention. The additive components may be esterified, for example, with an alcohol, more particularly by a monoalcohol. For example, the carboxylic anhydride vinyl aromatic monomer copolymer may be at least partially esterified by an aromatic, aliphatic, linear, or branched C1-C12 monoalcohol, preferably a C2-C8 monoalcohol. Also, a mixture of such alcohols may be suitable. Some examples of suitable alcohols are isopropyl, butyl alcohols, ether alcohols, and 2-ethyl-1-hexanol. From a performance standpoint, a butyl alcohol or ether alcohol is currently preferred. The alcohol is provided so as to esterify between about 50 and about 85 mole percent of the pendent dicarboxylic acid moieties of the polymer. Typically, the esterification reaction does not go fully to completion; thus, a slight excess of the alcohol is unreacted, i.e., between about a 1 and about 5 mole % excess over the desired degree of esterification. As known in the art, the rate of esterification may be controlled or accelerated using a suitable catalyst (e.g., acid, tin compounds). The advantageous properties of this invention can be observed by reference to the following examples, which illustrate but do not limit the invention.

### EXAMPLES

### Control Adhesive

The Control Adhesive (Formula 1) was compounded with typical procedures known to those skilled in the art. SIS Polymer (Kraton D1113) was first added with an anti-oxidant (Ethanox 310) to a hot, approximately 150° C., sigma-blade mixer under nitrogen blanket. The SIS was masticated over approximately ten minutes. After complete mastication of the SIS, hydrocarbon tackifying resis (Wingtack ET) was added in three increments over approximately 30 minutes. After complete incorporation of the resin, process oil (Nyflex 222B) was added over approximately 10 minutes.

### Adhesive Composition Samples

Five adhesive formulas were prepared (Formulas 2 through 6) each containing an additive comprising a partial ester of a low molecular weight maleated polymeric hydrocarbon ester having a number average molecular weight (Mn) of 370, a weight average molecular weight (Mw) of 500, was 9% wt/wt maleated, and esterified with butyl alcohol to an esterification ratio of 50%, in accordance with at least one embodiment of the present invention. In some formulations, the additive further contained a low molecular weight product with high maleic anhydride content, a styrene:maleic anhydride (S:MA) ratio of 1.5:1, a number average molecular weight (Mn) of 2,900 and a weight average molecular weight (Mw) of 7,000, and was esterified with an ether alcohol to an esterification ratio of 75%. The molecular weight ranges were measured by GPC (gel permeation chromatography) with polystyrene standards in THF (tetrahydrofuran).

The caustic removable hot melt adhesive with additive was prepared in the following general manner using the same general procedure as the control adhesive. Adhesive Formulas 2 through 6 were compounded by first adding the SIS Polymer (Kraton D1113), the SMA ester and the anti-oxidant (Ethanox 310) to a hot, approximately 150° C., sigma-blade mixer under nitrogen blanket. The mixture was mixed until masticated over approximately ten minutes. After complete mastication of the SIS, the hydrocarbon tackifying resin (Wingtack ET) was added in three increments over approximately 30 minutes. After complete incorporation of the resin the liquid maleated polymeric hydrocarbon ester and the process oil (Nyflex 222B) was added over approximately 10 minutes. Table 1 details the composition of the adhesive formulations tested.

TABLE 1
Sample Formulas Tested (in w/w %)

| | | | | | Additive | | |
|---|---|---|---|---|---|---|---|
| | | | | | | Styrene- | |
| | | Hydrocarbon | | | | maleic | |
| | SIS Block | tackifying | Process | Anti- | Total | Anhydride | |
| | Copolymer | resin | Oil | oxidant | Weight | Ester | Maleated C5 |
| Sample | (Kraton D- | (Wingtack | (Nyflex | (Ethanox | % of | (SMA | Hydrocarbon |
| Formula | 1113) | ET) | 222B) | 310) | Additive | Ester) | Ester |
| 1 | 41.3 | 49.5 | 8.2 | 1.0 | 0.0 | 0.0 | 0.0 |
| (Control) | | | | | | | |
| 2 | 39.3 | 47.2 | 7.9 | 0.9 | 4.7 | 0.0 | 4.7 |
| 3 | 37.5 | 45.0 | 7.5 | 0.9 | 9.0 | 0.0 | 9.0 |
| 4 | 34.4 | 41.3 | 6.9 | 0.8 | 16.5 | 8.3 | 8.3 |
| 5 | 37.5 | 45.0 | 7.5 | 0.9 | 9.0 | 6.8 | 2.3 |
| 6 | 37.5 | 45.0 | 7.5 | 0.9 | 9.0 | 4.5 | 4.3 |

The sample formulas were initially tested for compatibility. It is noted that the combination additive of the present invention was found to be compatible with the components of conventional hot melt adhesives. The caustic removable hot melt adhesive and additive mixed uniformly during compounding with a Sigma mixer. There was no phase separation at room temperature or in the 170° C. oven-heated samples (i.e., uniform cross-section).

Dynamic Mechanical Analysis was also performed on these samples, using a TA Instruments Rheometer AR 2000 on an 8 mm parallel plate. Dynamic Mechanical Analysis (DMA) is a thermo-mechanical analytical technique used to study the characteristics of materials such as the viscoelastic nature of polymers and polymer blends. An oscillating force is applied to a sample of material and the resulting displacement of the sample is measured. The samples can be either solids, which are tested by linearly applied strains, or melts or liquids, which are normally tested in shear. The DMA sample deforms under the applied load. From this the stiffness of the sample can be determined, and the sample modulus can be calculated. It is possible to determine the damping properties of a material by measuring the time lag in the displacement compared to the applied force. The time lag is reported as a phase lag angle. The damping is called tan delta (δ), as it sis reported as the tangent of the phase lag. Viscoelastic materials such as polymers typically exhibit the properties of a glass (high modulus) at low temperatures, and those of a rubber (low modulus) at higher temperatures. This change of state, i.e., glass transition or alpha relaxation, can be observed by scanning the temperature during a DMA experiment. The samples were observed for broadening of the tan δ peak, and/or the appearance of a second peak indicating a change of state, under the DMA. Table 2, below, presents the numerical results of the Dynamic Mechanical Analysis.

TABLE 2
Dynamic Mechanical Analysis

| | | Temp | | Temp | Storage | Storage |
|---|---|---|---|---|---|---|
| | Peak | 1^{st} | Temp 2^{nd} | 3^{rd} | Modulus | Modulus |
| Sample | Tan δ | X-over | X-over | X-over | G′ (Pa) | G′ (Pa) |
| Formula | (° C.) | (° C.) | (° C.) | (° C.) | at 25° C. | at 40° C. |
| 1 | −7.6 | −26.7 | 8.4 | 101.9 | 47240 | 33550 |
| (Control) | | | | | | |
| 2 | −0.7 | −17.9 | 15.5 | 107.9 | 41720 | 26410 |
| 3 | −0.7 | −16.7 | 14.4 | 107.9 | 42790 | 28470 |
| 4 | −0.6 | −16.8 | 15.4 | 105.9 | 50490 | 32610 |
| 5 | −0.2 | −15.8 | 15.4 | 108.9 | 46160 | 29060 |
| 6 | −0.6 | −16.9 | 15.5 | 106.9 | 44050 | 26010 |

The overall results, as shown in Table 2, demonstrate that the essential viscoelastic performances of the adhesive composition are not significantly affected when an additive according to an embodiment of the present invention is added to a conventional hot melt adhesive. Visual observations were made of the formulations in a Sigma mixer, of oven heated samples heated to 170° C., and of the applied film during coating. The results showed compatible transparent adhesive films for the adhesive of the invention containing the additive.

An adhesive label of the present invention may be prepared by various methods known to one having ordinary skill in the art. In one preferred embodiment, the adhesive is melted and poured onto a blade coater so that a thin film of it can be applied to a release liner to which a face stock is laminated. The laminate is then cut into label size strips. To test the label, the release liner is removed and the label is applied to a substrate and rolled with a 4.5 lb. roller. Typical adhesive properties such as tack, peel and shear can be measured and compared with adhesives not containing the combination additive of the present invention. For adhesion tests, the adhesives were heated to 170° C. and coated onto a release liner and immediately laminated to a 2 mil thick (50 micron) polyethylene terephthalate (PET) polyester film. The initial adhesive properties were measured after aging the coated adhesive sheets for 24 hours at 23° C. and 50% relative humidity (R.H.). Aged adhesive properties were measured after aging the coated sheets for 1 week at 70° C. followed by a minimum of 24 hours at 23° C. and 50% R.H. The aged adhesion results, when compared to the initial adhesion properties, showed that the adhesion properties were not significantly different.

The sample formulas were tested using standard test methods established by the Pressure Sensitive Tape Council (PSTC). The sample formulas were tested for peel strength, according to PSTC Method 101 “International Standard for Peel Adhesion of Pressure Sensitive Tapes.” Peel adhesion is the force required to remove a pressure sensitive tape from a test panel or its own backing at a controlled angle and at a standard rate and condition. The sample formulas were tested for their adhesion to high density polyethylene (HDPE), stainless steel (SS), and glass substrates at an angle 180 degrees. The sample formulas were further tested using HDPE, SS, and glass substrates for loop tack under PSTC Method 16. The results of these tests are shown in Table 3 below.

TABLE 3
Initial Adhesion Performance

| | SMA | | | | | | | |
|---|---|---|---|---|---|---|---|---|
| | Ester/ | | | | | | | |
| | Maleated | | Peel Adhesion | | | Loop Tack Adhesion | | |
| | C5 | | | on | on | | on | on |
| | Hydro- | | on SS | Glass | HDPE | on SS | Glass | HDPE |
| Sample | carbon | Total | N/m | N/m | N/m | N/m | N/m | N/m |
| Formula | Ester | Additive % | (lbf/in) | (lbf/in) | (lbf/in) | (lbf/in) | (lbf/in) | (lbf/in) |
| 1 | 0.0/0.0 | 0.0 | 1219 (7.0) | 1042 (6.0) | 358 (2.0) | 1102 (6.3) | 849 (4.9) | 431 (2.5) |
| (Control) | | | | | | | | |
| 2 | 0.0/4.7 | 4.7 | 1146 (6.5) | 1079 (6.2) | 444 (2.5) | 1122 (6.4) | 1220 (7.0) | 385 (2.2) |
| 3 | 0.0/9.0 | 9.0 | 1275 (7.3) | 1072 (6.1) | 549 (3.1) | 1190 (6.8) | 1196 (6.8) | 519 (3.0) |
| 4 | 8.3/8.3 | 16.5 | 715 (4.1) | 675 (3.9) | 436 (2.5) | 787 (4.5) | 910 (5.2) | 371 (2.1) |
| 5 | 6.8/2.3 | 9.0 | 1172 (6.7) | 931 (5.3) | 468 (2.7) | 932 (5.3) | 995 (5.7) | 417 (2.4) |
| 6 | 4.5/4.5 | 9.0 | 1241 (7.1) | 1088 (6.2) | 637 (3.6) | 1045 (6.0) | 1048 (6.0) | 486 (2.8) |

Additionally, the shear adhesion failure temperature was measured for each of the samples. The recorded shear adhesion failure temperature for each of the samples was 65.4° C. for the control sample 1, 62.9° C. for sample 2, 64.5° C. for sample 3, 67.1° C. for sample 4, 67.8° C. for sample 5, and 65.4° C. for sample 6.

The components of the adhesive may be adjusted to achieve specifically desired adhesion properties. The amount of each component can be varied to balance adhesion characteristics and initial compatibility with conventional hot melt formulations, while increasing water-resistance and caustic removability. For example, when a combination of SMA ester and maleated C5 hydrocarbon ester is used as the additive, a limited and acceptable decrease in overall adhesive properties was identified by the peel and loop tack tests. However, the combination additive was very compatible with conventional hot melt adhesive formulas containing SIS block copolymers, hydrocarbon resins, tackifier resins, and process oil with overall unaffected viscoelastic performance metrics, as shown in Table 2 above.

The additive of the present invention was found to be compatible with conventional hot melt adhesives while also enabling them to be caustic removable. This additional characteristic is useful for many purposes, particularly in the recycling process. Samples of Formulas 1 through 6 were tested for caustic removability. The adhesive Formulas were heated to 170° C. and coated onto 12 inch by 1 inch (30.48 cm by 2.54 cm) adhesive strips of unbleached Kraft 30 lbs/ream paper to test caustic removability and cold water resistance. The labels were adhered to flat glass panels and rolled with a 4.5 lb roller. The glass panels were immersed in a hot caustic bath consisting of 2.5% sodium hydroxide in water, heated to 80° C. Slight agitation was applied to the caustic bath.

The samples were timed for how long it took to remove the labels from the panels and the adhesion was rated for the amount of adhesive residue left on the panels. Glass panels are kept immersed in the aqueous solution of NaOH at 2.5% at 80° C. for a maximum of 5 minutes. Then, the strip adhesion (i.e., caustic removability) is measured and given a rating from 0 to 5, where 5 represents easy removal from the panel and no residue left on the panel and 0 represents no removal of the test strip (i.e., the adhesive remains on the panel).

TABLE 4
Caustic Removability Tests

| | | Total | |
|---|---|---|---|
| Sample | SMA/Maleated Polymeric | Additive | Rate of |
| Formula | Hydrocarbon Ester | (wt %) | Removability |
| 1 (Control) | 0.0/0.0 | 0.0 | 0 |
| 2 | 0.0/4.7 | 4.7 | 1 |
| 3 | 0.0/9.0 | 9.0 | 1 |
| 4 | 8.3/8.3 | 16.5 | 5 |
| 5 | 6.8/2.3 | 9.0 | 5 |
| 6 | 4.5/4.5 | 9.0 | 5 |

The results in Table 4 above show that the samples containing an additive composition containing both SMA ester and maleated polymeric hydrocarbon ester (i.e., samples 4, 5, and 6) are easily removable with a rate of 5 on glass. As would be appreciated by one having ordinary skill in the art, and as discussed above, the additive composition and the adhesive composition may be formulated to achieve specifically desired adhesion properties. The amount of the additive components can be varied to balance adhesion characteristics and initial compatibility with conventional hot melt formulations, while increasing water-resistance and caustic removability.

While preferred embodiments of the invention have been shown and described herein, it will be understood that such embodiments are provided by way of example only. Numerous variations, changes, and substitutions will occur to those skilled in the art without departing from the spirit of the invention. Accordingly, it is intended that the appended claims cover all such variations as fall within the spirit and scope of the invention.

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. An additive composition for imparting caustic removability to a hot melt adhesive, said additive composition comprising:
an ester functionalized polymer comprising a polymeric backbone and, pendent thereon, one or more dicarboxylic acid moieties in at least partial ester form; and
an at least partial ester of a low molecular weight α,β ethylenically unsaturated anhydride-containing or acid-containing polymer selected from the group consisting of a partial ester of a low molecular weight maleic anhydride homopolymer, a partial ester of a low molecular weight maleic anhydride olefin copolymer, and partial ester of a low molecular weight maleic anhydride vinyl aromatic copolymer.

2. The additive composition of claim 1, wherein a portion of the polymeric backbone is aliphatic.

3. The additive composition of claim 1, wherein the polymeric backbone has a weight average molecular weight less than 50,000.

4. The additive composition of claim 1, wherein the polymeric backbone is a homopolymer of a C3 to C16 monomer or a copolymer of two or more C3 to C16 monomers.

5. The additive composition of claim 1, wherein the one or more dicarboxylic acid moieties is an at least partial ester of a dicarboxylic acid moiety derived from a functionalizing agent selected from the group consisting of maleic acid, maleic anhydride, fumaric acid, itaconic acid, tetrahydrophthalic acid, and tetrahydrophthalic anhydride.

6. The additive composition of claim 1, wherein the ester functionalized polymer is an at least partial ester of a maleic anhydride grafted butadiene polymer or an at least partial ester of a maleic anhydride grafted C5 hydrocarbon polymer.

7. The additive composition of claim 1, wherein the ester functionalized polymer is an at least partial ester of a maleic anhydride grafted hydrocarbon polymer containing a structure according to Formula I: 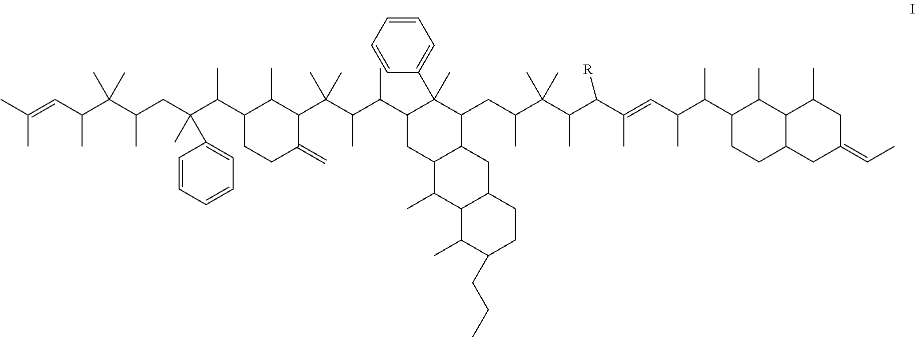
wherein R is a maleic anhydride or a dicarboxylic acid moiety, the dicarboylic acid moiety having a structure according to Formula II: 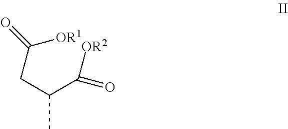
wherein R¹ and R² can be the same or different and are selected from H and any residue of an aromatic, aliphatic, linear, or branched C1-C12 monoalcohol, provided that at least a portion of the acid groups in the polymer are in ester form.

8. The additive composition of claim 1, wherein the at least partial ester of a low molecular weight α,β ethylenically unsaturated anhydride-containing or acid-containing polymer is a partial ester of a low molecular weight maleic anhydride vinyl aromatic copolymer.

9. The additive composition of claim 1, wherein the at least partial ester of a low molecular weight α,β ethylenically unsaturated anhydride-containing or acid-containing polymer is a partial ester of a low molecular weight styrene-maleic anhydride (SMA) copolymer.

10. The additive composition of claim 9, wherein the low molecular weight styrene-maleic anhydride (SMA) copolymer has a structure according to Formula III: 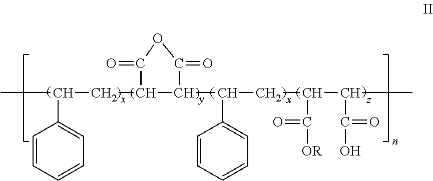
in which R is a residue of at least one monoalcohol selected from C1 to C12 monoalcohols, and their mixtures; n ranges from 7 to 72; and x, y, and z are such that a molar ratio of (x:(y+z)) is in the range from 1:1 to 3:1, and (z/(y+z)) ranges from 0.5 to 1.0.

11. The additive composition of claim 10, wherein the low molecular weight SMA ester has a ratio of styrene(S) : maleic anhydride(MA) of about 1:1 to about 3:1.

12. The additive composition of claim 10, wherein the low molecular weight SMA ester has a ratio of styrene(S) : maleic anhydride(MA) of about 1.4:1 to about 1.6:1.

13. The additive composition of claim 8, wherein the ester functionalized polymer is an at least partial ester of a maleic anhydride grafted hydrocarbon polymer and the at least partial ester of a low molecular weight maleic anhydride vinyl aromatic copolymer is a partial ester of a low molecular weight styrene-maleic anhydride (SMA).

14. A caustic removable hot melt adhesive composition comprising:
a hot melt adhesive additive comprising the additive composition of claim 1; and
an adhesive resin selected from the group consisting of styrene-isoprene block copolymers, polyacrylate resins, poly ethylene vinyl acetate (EVA) resins, polystyrene butadiene resins, random styrene butadiene (SBR) copolymers, styrene-butadiene block copolymers, styrene-isoprene-butadiene-styrene block copolymers, styrene-ethylene-propylene-styrene block copolymers, styrene-ethylene-butylene block copolymers, amorphous poly-α olefin (APAO) resins, and mixtures thereof.

15. A caustic removable adhesive label comprising:
a substrate, and
a caustic removable hot melt adhesive composition comprising
a hot melt adhesive additive comprising the additive composition of claim 1; and
an adhesive resin selected from the group consisting of styrene-isoprene block copolymers, hydrocarbon tackifying resins, polyacrylate resins, poly ethylene vinyl acetate (EVA) resins, polystyrene butadiene resins, random styrenebutadiene (SBR) copolymers, styrene-butadiene block copolymers, styrene-ethylene-butylene block copolymers, amorphous poly-α olefin (APAO) resins, and mixtures thereof.

16. (canceled)

17. The caustic removable adhesive label of claim 15, wherein the adhesive additive is soluble in a caustic solution having a pH greater than 8.

18. An article having a caustic removable adhesive label, wherein the article comprises
a container, and
a caustic removable adhesive label according to claim 15.

19. The article of claim 18, wherein the container is made from a material from the group consisting of glass, metal, and plastic.

20. The additive composition of claim 1, wherein the one or more dicarboxylic acid moieties are 50 to 100% esterified.

21. The additive composition of claim 1, wherein the one or more dicarboxylic acid moieties contain one or two ester groups having a structure —C(═O)OR wherein R is a C1 to C6 alkyl group.
